(19) United States
(12) Patent Application Publication
(10) Pub. No.: US 2012/0025052 A1
(43) Pub. Date: Feb. 2, 2012

(54) Aesthetic coasters

(75) Inventor: Steven Cheyene Brown, Toronto (CA)

(73) Assignee: Canadian Spirit Inc.

(21) Appl. No.: 12/804,668

(22) Filed: Jul. 27, 2010

(51) Int. Cl. A47G 23/03; B29C 45/14

(52) U.S. Cl. 248/346.11; 156/245

(57) ABSTRACT

An aesthetic coaster (which can also perform other conventional functions, such as paper weights, plant pot bases, art objects, etc.), and a method of making such a coaster, allow the production of a good quality coaster at a reasonable cost. A plastic coaster body having an aesthetic top surface and a recessed bottom surface is made by injection molding the plastic coaster body, then forming a micro layer of metal (e.g. aluminum) on at least the top surface of the plastic coaster body, and then coating at least the metal micro layer on the top surface with a low temperature catalytic lacquer that produces an imitation chrome, silver, brass, platinum, copper, bronze, or gold color. An insert (e.g. of mild steel) having a density significantly greater than the density of the plastic coaster body is inserted into a recess in the bottom surface and substantially permanently adhered within the recess. The insert and recess are covered with a covering (e.g. felt) which will not scratch furniture surfaces. The coaster desirably has about the same weight and feel as a similar sized coaster formed primarily or substantially completely of brass or bronze

### BACKGROUND AND SUMMARY

For many years aesthetic coasters for drink glasses (which coasters can also perform other conventional functions, such as paper weights, plant pot bases, art objects, or the like, which conventional functions are inherently incorporated within the term “coasters”) have been made of high quality, expensive metal such as brass or bronze. Because of the very high cost of such coasters, prior art techniques have been used to provide substantially the same aesthetic effect while making the coasters cheaper to produce. For example, a prior art coaster has been made from steel discs with brass sheet wrapped around a disc and bent at the bottom to hold the brass onto the steel disc, with the disc and bent brass bottom covered with felt. As a still less expensive prior art version, aluminum sheet has been used in place of the brass sheet, and a lacquer coating provided on the aluminum to provide a more aesthetic color (such as brass or silver).

According to the invention a coaster is provided that is just as functional, if not more functional, than the prior art coasters described that is even less expensive, yet still has substantially the same look as a brass or like high quality aesthetic coaster.

According to the invention, the coaster body is made of plastic having an aesthetic top surface (and side wall) and a recessed bottom. For some coasters, where optimum aesthetics is not required, the body may be made simply by injection molding using a highly polished mold cavity, and a glossy grade of plastic (e.g. black ABS). However most desirably, in order to substantially accurately simulate a high quality metal coaster, after the plastic coaster body is injection molded it is subjected to vacuum coating (sometimes also known as vacuum deposition, metallizing, or plating). In that process, aluminum (or other metal) is vaporized in a vacuum chamber so that the aluminum condenses to form a micro millimeter coating on the top surface of the plastic coaster body positioned within the vacuum chamber, and then the top surface of the plastic coaster body is coated with a low temperature catalytic lacquer. While under some circumstances the lacquer may be clear, most desirably the lacquer produces an imitation chrome, silver, brass, copper, bronze, or gold color.

While vacuum coating is definitely preferred, other conventional techniques capable of applying a micro layer of Al or other metal may alternatively be used.

While plastic per se has been used in drink coasters (e.g. see U.S. Pat. No. 5,150,869 and US Published Patent Application 2007/0034766), it has not believed known used as the visible part of an aesthetic coaster, as according to the invention.

According to one aspect of the invention, there is provided a method of making a coaster comprising: a) making a plastic coaster body having an aesthetic top surface and a recessed bottom surface; b) inserting an insert having a density significantly greater than the density of the plastic coaster body into the recess in the recessed bottom surface of the coaster body; c) substantially permanently adhering the insert within the recess; and d) providing the insert and recess with a covering which will not scratch furniture surfaces or the like.

In the method, b) may be practiced using a mild steel insert, and b) may be further practiced so that the coaster produced has about the same weight and feel as a similar sized coaster formed primarily or substantially completely of brass or bronze. Typically, c) is practiced using adhesive, such as by using double sided adhesive tape around the periphery of the insert, or using an adhesive between a large substantially flat top surface of the insert and a large substantially flat bottom surface of the body defining the recess. A felt or cork sheet-like covering may be used to practice d).

In one aspect of the invention, a) is practiced by injection molding using a highly polished mold cavity, and a glossy grade of ABS plastic (e.g. black). More universally, a) is practiced by a1) injection molding the plastic coaster body; then a2) vaporizing aluminum in a vacuum chamber so that the aluminum condenses to form a micro millimeter coating on at least the top surface of the plastic coaster body positioned within the vacuum chamber, or otherwise forming a micro layer of aluminum or other metal on at least the top surface of the plastic coaster body a3) then coating at least the top surface of the plastic coaster body with a low temperature catalytic lacquer. Typically, a3) is practiced with a lacquer that produces an imitation chrome, silver, brass, platinum, copper, bronze, or gold color.

According to another aspect of the invention, there is provided an aesthetic coaster comprising: a plastic coaster body having a substantially flat top surface with an annular raised periphery, and a bottom with a recess therein, at least the top surface of said plastic coaster body coated with a micro millimeter layer of aluminum, the aluminum covered with a lacquer with an imitation metal color; an insert substantially permanently held in said recess, said insert of a material having a density significantly greater than that of said coaster body; and a covering which will not scratch furniture surfaces covering said insert and recess.

The insert may be made of steel or the like, and desirably the coaster has a weight and feel substantially the same as if the coaster were formed substantially entirely of brass or bronze. The insert may be held in said recess by an adhesive acting between a substantially flat top surface of the insert and a substantially flat bottom surface of the coaster body within the recess. The covering may sheet felt held in place with pressure sensitive adhesive. Desirably, the imitation metal color is selected from silver, brass, chrome, platinum, copper, bronze, and gold.

The invention also relates to a coaster made by practicing any of the methods described above.

### BRIEF DESCRIPTION OF DRAWINGS

FIG. 1 is a box diagram illustrating an exemplary method according to the present invention;

FIG. 2 is a side exploded view, partly in cross section and partly in elevation, of a plastic coaster body and steel insert during assembly of a coaster according to the invention;

FIG. 3 is a view like that of FIG. 2 with the insert and body affixed together;

FIG. 4 is a view like that of FIGS. 2 and 3 of the completed coaster with felt covering on the bottom;

FIG. 5 is a top perspective view of exemplary round coasters according to the invention; and

FIG. 6 is a top plan view of a polygonal (square) coaster according to the invention.

### DETAILED DESCRIPTION OF DRAWINGS

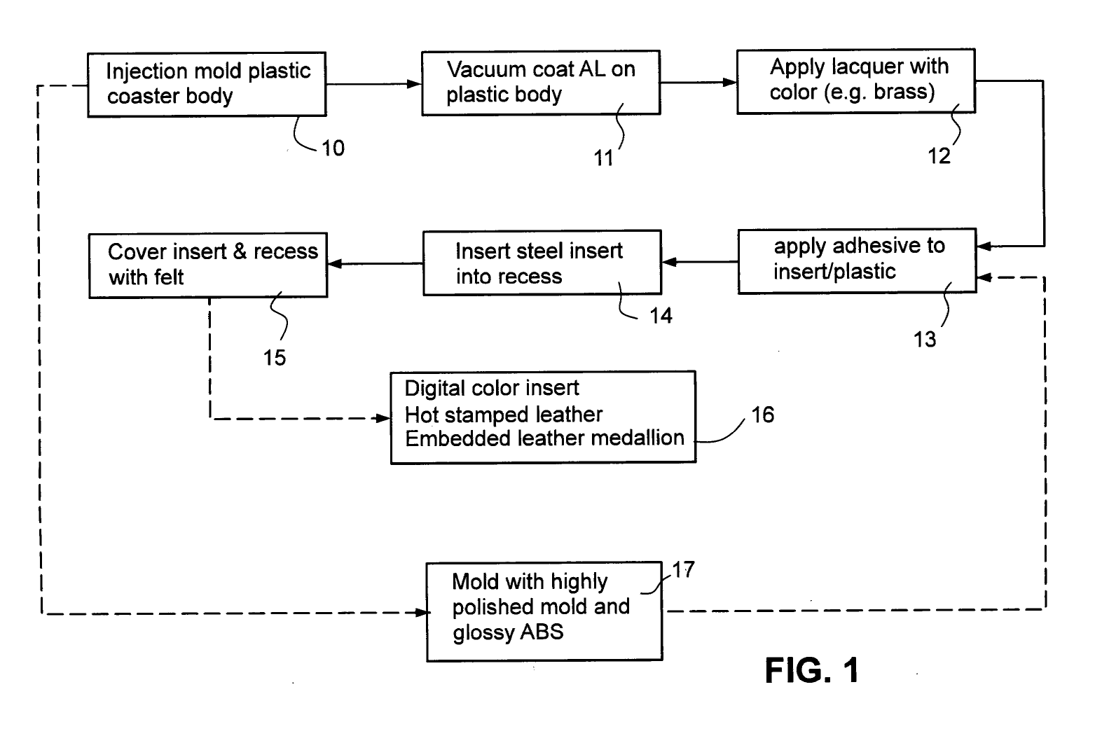

As seen in FIG. 1, in an exemplary method according to the invention, the coaster body is injection molded at 10 from any suitable high quality plastic, such as ABS. In the preferred method, forming the most aesthetic coaster, the plastic body is placed in a vacuum chamber and vacuum coated at 11 with aluminum or other suitable metal. That is, at 11 aluminum is vaporized in a vacuum chamber so that the aluminum condenses to form a micro millimeter coating on at least the top surface of the plastic coaster body positioned within the vacuum chamber. Then, at 12, at least the top surface (and side wall) of the plastic coaster body is coated with a low temperature catalytic lacquer, desirably one imparting an imitation expensive-looking metal color, such as with a lacquer that produces an imitation chrome, silver, brass, copper, platinum, bronze, or gold color.

At 13, an adhesive is applied to a mild steel, or like relatively inexpensive dense material (e.g. iron or ceramic) insert, and/or to the interior of the plastic coaster body. The adhesive may be in the form of an adhesive coat between large substantially flat insert top and plastic body bottom surfaces, or a double faced tape around the periphery of the insert. The adhesive may be pressure sensitive, hot melt, or a type that cures by application of heat or some other conventional external stimulus.

After adhesive application at 13, at 14 the steel insert is inserted into the bottom recess of the plastic body with the adhesive holding the insert substantially permanently in place. Then, as is conventional, at 15 the insert (and recess) are covered with a material that will not scratch or mar furniture, preferably a felt sheet covering that bonds to the insert and periphery of the plastic body with an adhesive. Alternatively cork, leather, rubber, vinyl, or the like, either in sheet form or in the form of spaced feet, may be used in place of or in addition to felt.

Typically the plastic body has a raised annular periphery, and in many circumstances, as indicated at 16, and as is conventional per se, a digital color insert, hot stamped leather insert, or embedded leather medallion, is optionally provided on the top surface of the plastic coaster body within the area defined by the raised annular periphery. Also if desired a design could be formed on the top surface of the plastic coaster body during injection molding, or by an etching process or the like after molding and before procedures 11 and 12.

For a somewhat less desirable—though still aesthetic—version of the method of FIG. 1, the molding at 10 is done—as indicated at 17—with a highly polished mold and glossy plastic, such as black ABS. Then the procedures 11 and 12 are not necessary.

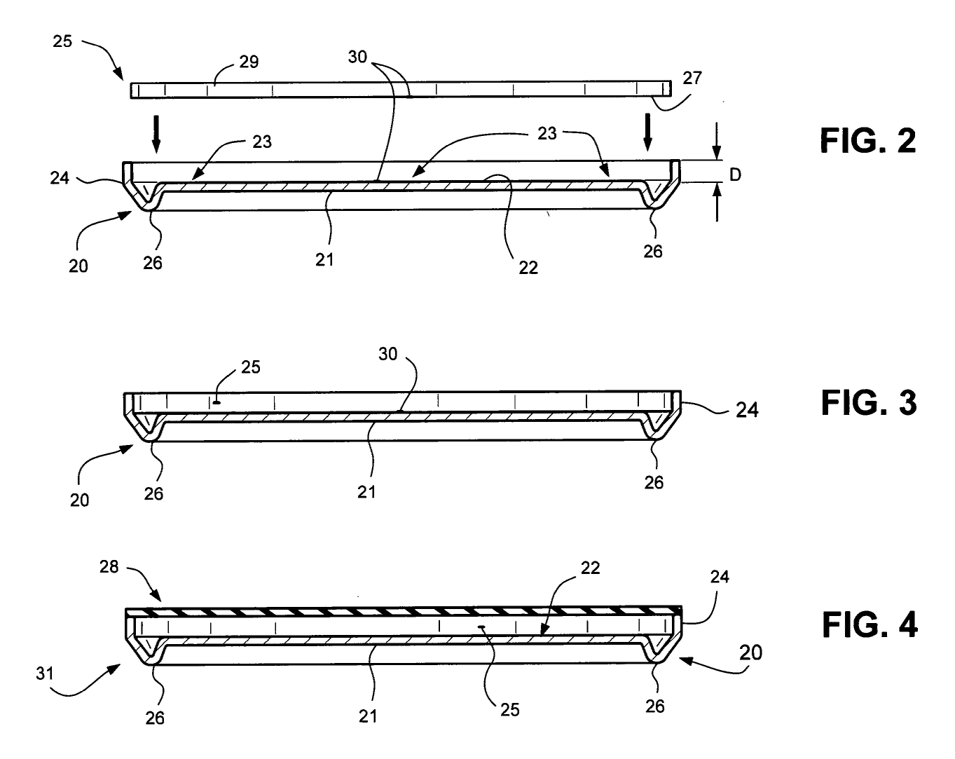

FIG. 2 shows, in cross-section, an exemplary plastic coaster body 20 according to the invention. The body has a substantially flat top surface 21, and a substantially flat bottom surface 22 at the bottom of a bottom recess 23. The bottom recess 23 is defined by the substantially annular side wall 24, which has a dimension D substantially the same as, or slightly less or greater than, the thickness of the insert 25. Also, preferably the coaster body 20 has a raised annular peripheral lip 26 defining the edge of the top surface 21, and the insert 25 has a substantially flat top surface 27.

The insert 25 typically has a thickness of about 2.5-5 mm (e.g. about 3.55 mm) and is in the form of a disc when the completed coaster (e.g. see 31 in FIGS. 4 & 5) is circular. While a number of different relatively inexpensive materials, such as iron and dense ceramic, may be used, preferably the insert 25 is of mild steel with substantially no burrs or other significant surface imperfections. Whatever the insert 25 material, it has a sufficient density and thickness (ultimately weight) so as to make the completed coaster (31 in FIGS. 4 & 5) feel like it is made of the material that the plastic body top surface simulates (e.g. brass, bronze, silver, etc.). Also, since the insert 25 takes up substantially the entire recess 23, the center of gravity and uniformity of feel of the completed coaster (31) is such as to also simulate a coaster primarily or substantially entirely of high quality material (such as brass).

FIG. 3 shows the insert 25 held substantially permanently in place within the recess 23 by an adhesive (shown only at spot 30 in FIGS. 2 & 3 but desirably almost completely coating one or both of the surfaces 27 and 22). Instead of an adhesive—which may be hot melt, pressure sensitive, heat or other external stimuli activated, etc.—between the surfaces 22, 27, a conventional double faced adhesive tape may be provided between the periphery of the insert 25 and interior of the annular side wall 24.

Another way that adhesive could be used to attach the components 20, 25, together would be to use a disc of double sided dry mount adhesive. The disc could be made as a die cut from wide strip double sided tape with suitable wax or polyethylene coated release papers as is established practice. A die cut disc of self adhesive dry mount the same size and shape as the insert 25 could pre-applied to the insert 25, and then the remaining protective backing removed immediately prior to insertion into the recess 23.

Another way of adhesively securing the components 20, 25, would be to extrude a generous bead of a silicone sealant or the like into the internal profile ‘V’ recess 23 of the coaster body 20, and then insert the steel plate 25. The result would be that the silicone would then extrude between the plate and molding flat surfaces and also in the space between the insert edge and the inside wall of the molding. Any surplus of adhesive could easily be wiped clean.

Still further, under some circumstances one could heat or cold swage the plastic body 20, such as at the sidewall 24, thereby deforming the plastic to trap the insert 25, obviating the need for adhesive. A felt base (as described below) could be suitably arranged to provide an adequately performing base. Still further, the inside of the side wall 24 could be molded with clips so that the insert 25 clips into place without adhesive or swaging.

FIG. 4 shows a side view of a completed coaster 31 having a covering 28 over the insert 25 and recess 23, preferably including the side wall 24, which covering 28 will not harm furniture or other surfaces on which the coaster 31 might be placed. In FIG. 4 the plastic coaster body and covering 28 are shown in cross-section, and the insert 25 in elevation. The covering 28 may be any conventional material, such as felt about 1 mm thick secured by conventional pressure sensitive adhesive to the bottom surface 29 of the insert 25 as well as the termination of the annular side wall 24. Other conventional materials that may be used for the covering 28 include, without limitation, cork, leather, vinyl, and rubber. The term “covering” is used herein generically, and includes a complete sheet-like covering as illustrated in FIG. 4, or spaced feet, as long as the covering 28 properly supports the coaster 21 to function properly as a coaster and so that it does not harm surfaces on which it is placed.

While the completed coaster 31 may have a wide variety of dimensions, typically it has a diameter of about 3.5-4 inches.

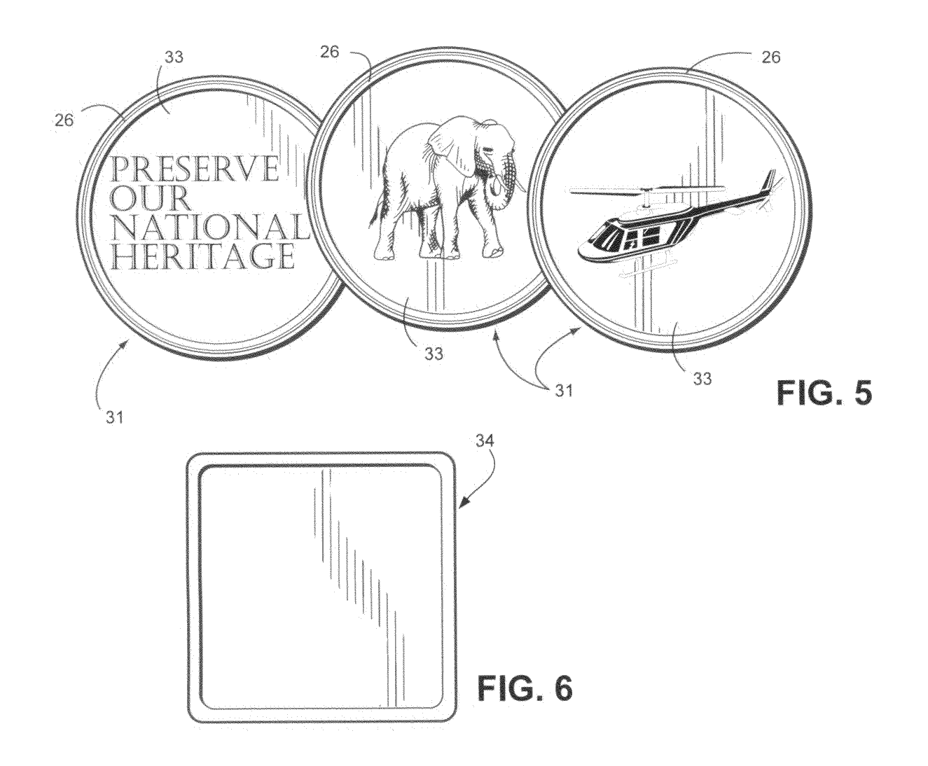

FIG. 5 provides a schematic perspective view of three circular coasters 31 according to the invention. In each case within the area defined by the raised annular periphery 26 of the coaster plastic body 20 there is provided (in a manner conventional per se, as schematically illustrated at 17 in FIG. 1) a custom or standard digital color insert, hot stamped leather insert, or embedded leather medallion, 33.

While normally the coasters 31 are circular, they may be of a wide variety of shapes, such as ovals, clover leafs, hearts, or polygons. One polygonal form (square as illustrated) of a coaster 34 is illustrated schematically in FIG. 6. Whatever the shape, the insert (25) will typically have substantially the same shape as the plastic body (20), for example square in the case of the FIG. 6 coaster 34.

While the invention has been described with respect to preferred embodiments, it is to be understood that the invention is to be interpreted to cover all reasonable equivalents, and the invention is to be accorded the broadest interpretation possible consistent with the prior art.

1. A method of making a coaster comprising:
a) making a plastic coaster body having an aesthetic top surface and a recessed bottom surface;
b) inserting an insert having a density significantly greater than the density of the plastic coaster body into the recess in the recessed bottom surface of the coaster body;
c) substantially permanently adhering the insert within the recess; and
d) providing the insert and recess with a covering which will not scratch furniture surfaces or the like.

2. A method as recited in claim 1 wherein b) is practiced using a mild steel insert.

3. A method as recited in claim 2 wherein b) is further practiced so that the coaster produced has about the same weight and feel as a similar sized coaster formed primarily or substantially completely of brass or bronze.

4. A method as recited in claim 1 wherein c) is practiced using adhesive.

5. A method as recited in claim 4 wherein c) is further practiced using double sided adhesive tape around the periphery of the insert, or using an adhesive between a large substantially flat top surface of the insert and a large substantially flat bottom surface of the body defining the recess.

6. A method as recited in claim 1 wherein d) is practiced using a felt or cork sheet-like covering.

7. A method as recited in claim 1 wherein a) is practiced by injection molding using a highly polished mold cavity, and a glossy grade of ABS plastic.

8. A method as recited in claim 1 wherein a) is practiced by a1) injection molding the plastic coaster body; then a2) vaporizing aluminum in a vacuum chamber so that the aluminum condenses to form a micro millimeter coating on at least the top surface of the plastic coaster body positioned within the vacuum chamber; and a3) then coating at least the top surface of the plastic coaster body with a low temperature catalytic lacquer.

9. A method as recited in claim 7 wherein a3) is practiced with a lacquer that produces an imitation chrome, silver, brass, platinum, copper, bronze, or gold color.

10. A method as recited in claim 1 wherein a) is practiced by a1) injection molding the plastic coaster body; then a2) forming a micro layer of metal on at least the top surface of the plastic coaster body; and a3) then coating at least the metal micro layer on the top surface of the plastic coaster body with a low temperature catalytic lacquer that produces an imitation chrome, silver, brass, platinum, copper, bronze, or gold color.

11. A method as recited in claim 10 wherein b) is practiced so that the coaster produced has about the same weight and feel as a similar sized coaster formed primarily or substantially completely of brass or bronze.

12. An aesthetic coaster comprising:
a plastic coaster body having a substantially flat top surface with an annular raised periphery, and a bottom with a recess therein, at least the top surface of said plastic coaster body coated with a micro millimeter layer of aluminum, the aluminum covered with a lacquer with an imitation metal color;
an insert substantially permanently held in said recess, said insert of a material having a density significantly greater than that of said coaster body; and
a covering which will not scratch furniture surfaces covering said insert and recess.

13. A coaster as recited in claim 12 wherein said insert is made of steel or the like and wherein the coaster has a weight and feel substantially the same as if the coaster were formed substantially entirely of brass or bronze.

14. A coaster as recited in claim 12 wherein said insert is held in said recess by an adhesive acting between a substantially flat top surface of said insert and a substantially flat bottom surface of said coaster body within said recess.

15. A coaster as recited in claim 12 wherein said covering is sheet felt held in place with pressure sensitive adhesive.

16. A coaster as recited in claim 12 wherein said imitation metal color is selected from silver, brass, chrome, platinum, copper, bronze, and gold.

17. A coaster as recited in claim 13 wherein said insert is held in said recess by an adhesive acting between a substantially flat top surface of said insert and a substantially flat bottom surface of said coaster body within said recess.

18. A coaster as recited in claim 13 wherein said covering is sheet felt held in place with pressure sensitive adhesive.

19. A coaster as recited in claim 13 wherein said imitation metal color is selected from silver, brass, chrome, platinum, copper, bronze, and gold.

20. A coaster made by practicing the method of claim 11.
